(19) United States
(12) Patent Application Publication
(10) Pub. No.: US 2011/0078725 A1
(43) Pub. Date: Mar. 31, 2011

(54) MULTI-MEDIA AUDIO/VISUAL ADVERTISING SYSTEM

(76) Inventor: George E. Steinhoff, Bonita Springs, FL (US)

(21) Appl. No.: 12/894,875

(22) Filed: Sep. 30, 2010

Related U.S. Application Data
(63) Continuation of application No. 11/402,794, filed on Apr. 13, 2006, now abandoned.
(60) Provisional application No. 60/594,502, filed on Apr. 13, 2005.

(51) Int. Cl. H04N 7/10

(52) U.S. Cl. 725/32

(57) ABSTRACT

The multi-media audio/visual advertising system of the present invention includes a plurality of visual monitors and audio/visual sources that are strategically located where large groups of people gather. The audio/visual advertising programming on the multi-media audio/visual advertising system may run up to twenty-four hours a day and consists of a plurality of audio/visual slots. The audio/visual advertising is capable of audio or textual presentation of the audio source on the plurality of visual monitors. Each one of the plurality of audio/visual slots is sold to advertisers who have the option of purchasing multiple visual slots to create visual advertising programming of a desired duration. The multi-media visual advertising system allows monitors to be placed at multiple locations and display an audio/visual presentation that gives an advertiser a huge advantage over a competitor that merely uses background art billboard advertising systems.

This application is a continuation of co-pending application Ser. No. 11/402,794, filed on Apr. 13, 2006, and for which priority is claimed under 35 U.S.C. §120; and this application claims priority of U.S. Provisional Application No. 60/594,502 filed on Apr. 13, 2005 under 35 U.S.C. §119; the entire contents of all are hereby incorporated by reference.

### BACKGROUND OF THE INVENTION

The present invention relates generally to electronic billboards and more particularly to a system for improving the ability to provide multi-media preprogrammed audio/visual advertising.

Advertising of products may take on many forms including television commercials, magazine ads, mailings and indoor/outdoor billboards. In particular, billboards in the background art have been used in advertising to display various messages that typically consisting of a combination of text and graphics to catch the attention of the consumer. With traditional billboards, the advertisement has been provided by way of still pictures pasted to a backing. However, a problem with this traditional approach to billboard advertising is the inability to quickly change the displayed advertisement. Since it requires the use of a crew of men to physically go to the site of the billboard and change the content of the billboard by pasting a new advertisement to the backing.

More recently, electronic billboards have been developed that make it easier to update a message that is being displayed on the billboard. Background art versions of these electronic billboards have included: (1) illuminated still pictures with typical dimensions of 7′.times.4; or (2) dot matrix type displays that utilize many individual bulbs to make up the matrix. With regard to illuminated still picture electronic billboards, they typically have a viewing radius of approximately 50.′ However, the radius limits the effectiveness of these types of electronic billboards when large groups of people gather. Dot matrix electronic billboards are used, for example, at stadiums, arenas and convention centers, for instant replays, advertising and customer information. However these types of electronic billboards suffer from a variety of problems such as lack of good graphics capabilities, poor contrast ratios and/or requiring significant amounts of power.

Improvements in background art billboard advertising systems have also emphasized dynamic-content. In particular, dynamic-content is defined as information or data to be visually displayed that is updatable or changeable under electronic control. Elements of billboard advertising that have been subject to such updating in the background art have included pixel data in a digitized image, analog beam modulation for a cathode ray tube display, or streaming video provided to a display over a network. These background art solutions have often emphasized a single server or master control of video displays by operating over a computer network to provide these updates. Some background art advertising systems have even included direct control of billboard content by advertisers connected to such a network of video billboards. However, these background art video advertising systems are typically limited to video only presentations. In addition, these systems suffer from a single-point failure problems of centralized control systems and dependence on a network for information transmittal. Such background art approaches do not take full advantage of the possibilities of distributed processing and control offered by the latest advanced audio/visual and electronic technologies.

Advertisers are always interested in reaching the largest possible audience with the least advertising dollars. More efficient, effective and economical ways of advertising are needed in the art to make this goal obtainable. Advances in audio/visual display and electronic technologies are making eye-catching, multi-media audio/visual and textual sources common-place in the consumer market-place. Therefore, there is a need in the art for an improved electronic billboard system that utilizes these new technologies and overcomes the limitations and problems of the background art as discussed above.

### BRIEF SUMMARY OF THE INVENTION

The present invention is a multi-media audio/visual advertising system that takes advantage of advances in computer devices, monitors, audio/visual and electronic technologies in order to provide electronic billboards able to reach a larger audience. Advances in monitor and television technology include improved cathode ray tube (CRT) displays, liquid crystal (LCD) displays, plasma displays, projection screen televisions, and other materials capable of presenting audio/visual images. The advantages provided by high definition displays and high definition television include sharper and crisper features due to higher resolution.

In addition, larger monitor screen sizes are available that can be seen at a viewing radius that extends out to at least 100 feet. In particular, LCD and plasma displays provide a wider viewing angle than conventional CRT-based electronic billboard displays. These LCD and plasma displays have a viewing angle that extends to almost 180 degrees. High performance visual digital signal processing techniques are provided by faster and more powerful computer devices. These high-performance computers are now embedded in almost all electronic equipment and particularly in monitors and audio/visual sources in support of high definition and digital signal processing.

Advances in computer devices include the ability to implement high-performance digital signal processing in real-time and distributed processing. The real-time signal processing capability provides for improved resolution in monitor displays and multi-media applications. In particular, these computer devices can also be programmed and integrated into an audio/visual system that can take even further advantage of the technology advances discussed above. Capabilities of these computer devices include advanced speech processing that allows audio information to be analyzed and presented on the monitor screen as textual data in real-time. The electronic/digital signal processing techniques include, but are not limited to: presenting tele-text data and closed-caption information as an alternative to audio information and simultaneously with the video portion of the advertising presentation. In addition, the distributed processing capability of the present invention provides improved performance for the overall system by avoiding the possibility of single-point failure problems in centralized control systems and the dependence on a network for information transmittal.

One embodiment of the present invention is a multi-media audio/visual advertising system comprising: at least one computer; at least one monitor; and at least one audio/visual signal source configured to provide inputs to the at least one monitor. In this embodiment, the computer controls the operation of the at least one monitor and selects which of the at least one audio/visual signal source is presented on the at least one monitor. In addition, in this embodiment the at least one monitor is placed in at least one of a plurality of possible locations at a host facility.

Preferably, in the present invention the at least one audio/visual source is at least one of internal and external to the at least one monitor. In addition, preferably the at least one audio/visual source is at least one of a compact disk, a digital visual disk, a VHS tape or other audio/visual source. Further, preferably the at least one audio/visual source is at least one of broadcast television, cable television, satellite television, the Internet, a computer and other sources of audio/visual signals. Furthermore, preferably the at least one monitor is at least one of a cathode ray tube, liquid crystal display, plasma display and projection television display or other technologies capable of presenting audio/visual signal sources. Furthermore, the at least one computer provides the capability to present at least one of audio source and a textual version of the audio source on the at least one monitor. The textual version of the audio source is for example, but not limited to: at least one of closed caption, tele-text and other devices/sources of converting audio-to-text. Moreover, preferably the at least one monitor has a display with at least a 3″ display screen.

Another embodiment of the present invention is a method for multi-media audio/visual advertising, comprising: (1) strategically placing a plurality of monitors throughout a host facility; (2) dividing a predetermined interval of time into a plurality of time segments; (3) selling at least one of the plurality time segments as advertising audio/visual slots; (4) combining the advertising audio/visual slots into a audio/visual advertising presentation lasting for the duration of a predefined time frame; (5) displaying the audio/visual advertising presentation on at least one of the plurality of monitors; (6) presenting at least one of an audio source and a textual version of the audio source on at least one of the plurality of monitors; and (7) repeating the audio/visual advertising presentation after the end of the predefined time frame.

Preferably, in the present invention the predefined time frame is in the range of 15 minutes to 1 hour. In addition, preferably the predetermined time interval is in the range from 10 seconds to 1 minute. Furthermore, the textual version of the audio source is for example, but not limited to: at least one of closed caption, tele-text and other devices/sources for converting audio-to-text. Moreover, preferably the audio/visual slots may be updated at least every 1 to 90 days.

### BRIEF DESCRIPTION OF DRAWINGS

FIG. 1 illustrates an exemplary first embodiment of the audio/visual advertising system of the present invention.

FIG. 2 illustrates an exemplary second embodiment of the audio/visual advertising system of the present invention.

FIG. 3 illustrates an exemplary third embodiment of the audio/visual advertising system of the present invention.

FIG. 4 illustrates an exemplary flow diagram of a method of the present invention.

### DETAILED DESCRIPTION OF THE PREFERRED EMBODIMENT

The present invention is a multi-media audio/visual advertising system comprising at least one computer; at least one monitor; and at least one audio/visual signal source. In addition, the at least one computer controls the operation of the at least one monitor and selects which of the at least one audio/visual signal source is presented on the at least one monitor. Further, the at least one audio/visual source provides audio/visual inputs to the at least one monitor. Furthermore, the at least one monitor is placed in at least one of a plurality of possible locations at a host facility. Moreover, the host facility may comprise, but is not limited to: airports, convention centers, arenas, stadiums, shopping malls, public transportation, buildings and other places where advertising may be presented to a gathering of large numbers of people.

In the present invention, at least one computer, located in at least one of the monitor and the audio/visual source: (1) controls the multi-media audio/visual advertising system and (2) repeats audio/visual advertisement in accordance to user programming; a data source configured to provide an audio/visual signal to the audio/visual source; and the at least one monitor displays audio/visual advertisement programming that is provided by the at least one audio/visual source on a predetermined basis over predefined time intervals in accordance with user programming. The predetermined basis may comprise, but is not limited to: a programming schedule defined by a user and programmed into at least one of the computers and the audio/visual sources of the multi-media audio/visual advertising system. The predefined time intervals include, but are not limited to: intervals of at least one of seconds, minutes, hours and days.

In a first embodiment of the present invention, a monitor is combined with an audio/visual source in a single unit. The monitor produces audio outputs from at least one of a speaker and audio producing device; and visual outputs from at least one of a display screen and visual display device from the audio/visual source signal. Alternatively, the at least one monitor may be a television apparatus capable of receiving and displaying at least one of an analog and digital signal from at least one of broadcast television, cable television, satellite television and other audio/visual signal sources. The multi-media audio/visual advertising system of this embodiment utilizes at least one of an AC and DC power source, wherein the DC power source may further comprise, but is not limited to at least one of a battery and a DC generator.

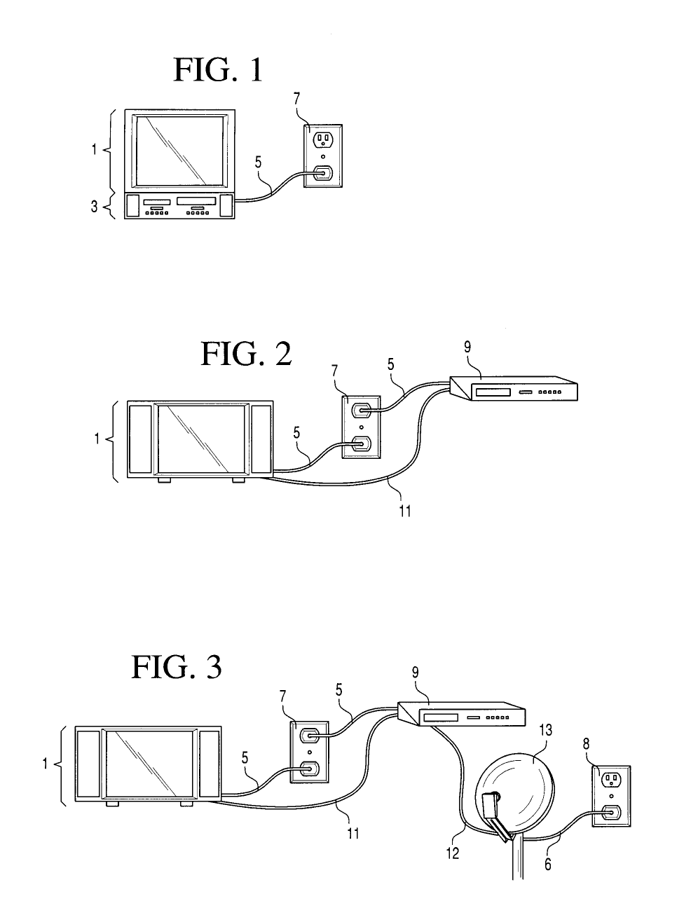

FIG. 1 illustrates an exemplary first embodiment of the invention. In particular, FIG. 1 shows a single unit multi-media audio/visual advertising system comprising a monitor 1 and audio/visual source 3. At least one computer (not shown) is internal to the single unit multi-media audio/visual advertising system of FIG. 1 and is located in at least one of the monitor 1 and the audio/visual source 3. The monitor 1 is at least one of a cathode ray tube (CRT), liquid crystal display (LCD) plasma display, projection display and other display technologies. The audio/visual source 3 may be a data source or device that provides output signals from at least one of, but not limited to: a compact disk (CD), digital video disk (DVD), video tape, broadcast television, cable television, satellite television, CD Rom machines, microwave sources, satellite sources, computers, hard drives, memory chips (e.g., RAM, ROM, compact flash), telephone, holographs, laser, radio telephones, the Internet and memory cards (e.g., compact flash). The audio/visual source may use any of many popular formats including, but not limited to: cassette tape (e.g., standard or mini sizes), ½″ Beta machine, Hi8, and Mini-DV, VHS, VHS-c, super VHS, VHS Digital, Beta cam, ¾″ video tape, 1″ video tape, 2″ video tape, digital, Beta cam digital, ¾″ digital and 2″ digital.

In the embodiment shown in FIG. 1, a power cord 5 connects the audio/visual advertising system to an AC power source 7. The AC power source may comprise, but is not limited to: 120 VAC and 240 VAC.

In a second embodiment of the present invention, at least one monitor is connected to at least one audio/visual source. At least one computer, located inside of at least one of the monitors and audio/visual sources, controls the operation of the multi-media audio/visual advertising system. The connection between the monitors and audio/visual sources may comprise, but is not limited to: at least one of a cable and a wireless connection. The cable comprises, but is not limited to: type RG-58 coax cable, type RG-59 coax cable and other standard audio/visual capable interconnects. The wireless connection comprises, but is not limited to: radio frequency and infra-red wireless connection means.

In addition, the at least one monitor may further comprise a television apparatus capable of receiving and displaying at least one of an analog and digital signal from at least one of broadcast, cable and satellite television signal sources as well as other audio/visual sources (e.g., VHS player, digital camera, DVD player). The monitors and audio/visual sources of the audio/visual advertising system of this embodiment utilize at least one of AC and DC power sources, wherein the DC power source may further comprise at least one of a battery, a generator and other well known equipment capable of providing DC power.

FIG. 2 illustrates an exemplary second embodiment of the present invention. In particular, FIG. 2 is a multiple unit audio/visual advertising system that may include a plurality monitors and plurality of audio/visual sources. As shown in FIG. 2, a cable 11, capable of carrying audio/visual signals, is connected between the monitor 1 and an audio/visual source 9. The cable 11 is capable of carrying audio/visual signals that include at least one of, but are not limited to: composite video, S-Video, DVI and HDMI. The monitor 1 and the audio/visual source 9 are each powered by at least one of AC and DC voltages that are connected by power cables 5 to an AC power source 7.

In a third embodiment of the present invention, at least one monitor is connected to at least one audio/visual source and at least one means for receiving a television signal. A computer, located inside of at least one of the monitors and audio/visual sources, controls the operation of the overall audio/visual advertising system. The means for receiving a television signal comprise, but are not limited to: broadcast television antennas, satellite antennas, and cable television receivers. The connection between the monitors and audio/visual sources may comprise, but is not limited to: at least one of a cable and a wireless connection. The wireless connection may comprise, but is not limited to: radio frequency and infra-red frequency wireless connection means. The connection between the means for receiving and the audio/visual source are at least one of: coaxial cable and a radio frequency translator. The radio frequency translator provides a device capable of translating the output signal received by the means for receiving into a signal that can be interfaced directly to the inputs of audio/visual sources or directly to the monitors.

In addition, the at least one monitor may further comprise a television apparatus capable of receiving and displaying at least one of an analog and digital signal from at least one of broadcast, cable and satellite television signal sources and other audio/visual sources discussed above. The monitors, audio/visual sources and means of receiving for the audio/visual advertising system of this embodiment utilizes at least one of AC and DC power sources, wherein the DC power source may further comprise at least one of a battery, a generator and other well known equipment capable of providing DC power.

FIG. 3 illustrates an exemplary third embodiment of the present invention. In particular, FIG. 3 is a multiple unit audio/visual advertising system that may include a plurality monitors, audio/visual sources and means for receiving. As shown in FIG. 3, a cable 11, capable of carrying audio/visual signals, is connected between the monitor 1 and an audio/visual source 9. The cable 11 is capable of carrying audio/visual signals that include at least one of, but are not limited to: composite video, S-Video, DVI and HDMI. The monitor 1, audio/visual source 9, and means for receiving 14 are each powered by at least one of AC and DC voltages that are connected by power cables 5 to an AC power source 7 and power cable 6 to an AC power source 8. The power source 7 at the means for receiving 14 provides power for at least one of a pre-amplifier (not shown) and radio frequency translator (not shown) used to process signals at the output of the means for receiving 13. The means of receiving may comprise, but is not limited to: broadcast television antennas, satellite antennas, cable television receivers, cable modems; DSL modems and other methods of receiving and converting input signals to the means for receiving into audio/visual signals for further processing by a monitor or television apparatus.

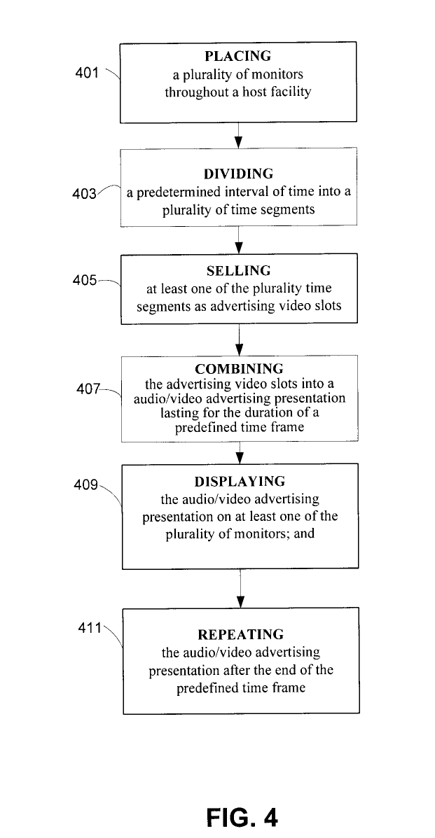

FIG. 4 is a flow diagram of an exemplary embodiment of the present invention. In step 401 of FIG. 4, a plurality of monitors is strategically placing throughout a host facility. In addition, Step 401 of strategically placing further comprises evaluating several factors such as, but not limited to traffic in the monitor location area, accessibility, availability of power sources; and number of people in the potential audience for the advertising during any given period of time. Step 403 of FIG. 4 involves dividing a predetermined interval of time into a plurality of time segments. In step 405, at least one of the plurality time segments is sold as advertising audio/visual slots. Step 407 involves combining the advertising audio/visual slots into an audio/visual advertising presentation lasting for the duration of a predefined time frame. Displaying the audio/visual advertising presentation on at least one of the plurality of monitors occurs in step 409. In step 411, the audio/visual advertising presentation is repeated after the end of the predefined time frame.

The foregoing description of the invention illustrates and describes the present invention. Additionally, though the disclosure shows and describes only the preferred embodiments of the invention in the context mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described herein above are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed as new and desired to be protected by Letters Patent of the United States is:

1. A multi-media audio/visual advertising system comprising: at least one computer; at least one monitor; and at least one audio/visual signal source, wherein the at least one computer controls the operation of the at least one monitor and selects which of the at least one audio/visual signal source is presented on the at least one monitor, wherein the at least one audio/visual source provides audio/visual inputs to the at least one monitor, and wherein the at least one monitor is placed in at least one of a plurality of possible locations at a host facility.

2. The system of claim 1, wherein the at least one computer provides the capability to present at least one of the audio source and a textual version of the audio source on the at least one monitor.

3. The system of claim 2, wherein the at least one audio/visual source is at least one of a compact disk, a digital visual disk and a VHS tape.

4. The system of claim 3, wherein the at least one audio/visual source is at least one of broadcast, cable and satellite television signal sources.

5. The system of claim 4, wherein the at least one monitor is at least one of a cathode ray tube, liquid crystal display, plasma display and projection television display.

6. The system of claim 5, wherein the at least one monitor is a plasma display with at least 50″ display screen.

7. The system of claim 5, wherein the textual version of the audio is provided by at least one of close-caption and tele-text data.

8. A method for multi-media audio/visual advertising, comprising: strategically placing a plurality of monitors throughout a host facility; dividing a predetermined interval of time into a plurality of time segments; selling at least one of the plurality time segments as advertising audio/visual slots; combining the advertising audio/visual slots into an audio/visual advertising presentation lasting for the duration of a predefined time frame; displaying the audio/visual advertising presentation on at least one of the plurality of monitors; presenting at least one of an audio source and a textual version of the audio source on at least one of the plurality of monitors; and repeating the audio/visual advertising presentation after the end of the predefined time frame.

9. The method of claim 8, wherein the predefined time frame is in the range of 15 minutes to 1 hour.

10. The method of claim 9, wherein the predetermined time interval is in the range from 10 seconds to 1 minute.

11. The method of claim 8, wherein the audio/visual slots may be updated at least every 90 days.

12. The method of claim 8, wherein the textual version of the audio source is provided by closed caption or tele-text sources.

13. The system of claim 1, wherein the textual version of the audio source is provided by closed caption or tele-text sources.
